(19) United States
(12) Patent Application Publication
(10) Pub. No.: US 2006/0174282 A1
(43) Pub. Date: Aug. 3, 2006

(54) Bi-directional signal coupler

(75) Inventors: Robert Dennison, Cambridge (GB); Alexander B. Chee, Marietta, GA (US)

Correspondence Address: Chun-Ming Shih, 4331 Stevens Battle Lane, Fairfax, VA, 22033, US

(73) Assignee: Pro Brand International, Inc.

(21) Appl. No.: 11/045,384

(22) Filed: Jan. 31, 2005

(51) Int. Cl. H04N 7/20; H04N 7/173

(52) U.S. Cl. 725/68; 725/105; 725/63; 725/71

(57) ABSTRACT

This invention is a signal coupler that works with, but is not restricted to multi-satellite, multi-receiver systems using one cable with a multi-slot transponder selector. The invention solves the difficulty of connecting a multi-output signal coupler to multiple receivers, where each receiver exhibits the characteristics of a master as specified by the DiSEqC protocol. By using a microcontroller with store and forward characteristics, it solves the issues of receiver command collisions, and is able to direct return commands (in DiSEqC 2.x systems) to only the receiver that initiated the communication.

### FIELD OF THE INVENTION

The present invention relates in general to a bi-directional signal coupler, and more particularly, to an innovative (“smart”) signal coupler for distribution of multi-satellite broadcast TV signals on a single coaxial cable line, allowing bi-directional data from each input and output, but with data collision protection and impedance buffering.

### BACKGROUND

Many communication systems use couplers, such as splitters (power dividers) and directional couplers for distributing a signal from a source, such as a satellite receiving antenna and electronics (e.g. satellite dish antenna and low-noise-block-down-converter (LNB), commonly referred to as the outdoor down-conversion electronics) to several receivers (e.g. satellite set-top-box receivers).

When such couplers are designed for use in the broadcast spectrum of 54-2150 MHz, they will generally exhibit an impedance that approximates to either a short or open circuit between outputs or between input and an output at low frequencies (e.g. DC to 200 kHz).

There are recent developments concerning the distribution of multi-satellite broadcast signals through one coaxial cable as the references, such as US patent application publication no. 2003/0023978 by Bajgrowicz, 2003/0141949 by Couet and 2003/0163822 by Knutson et al. The system, developed by Couet transmits four individual transponders as randomly requested by four different receivers, is particularly related to this invention. A conventional splitter is not suitable for this system for three reasons; one is command signal collision, the second is command confusion, and another is command signal device impedance matching issues.

There are two widely used conventional systems for the distribution of multi-satellite and multi-receiver direct broadcast satellite signals (DBS) in USA. One system is the matrix switch system, which is commonly called a multi-switch system; and the other is the stacked band and multi-switch hybrid system.

Conventional broadcast-satellite-service (BSS) and fixed-satellite-service (FSS) have 500 MHz downlink transmission spectrum, as shown in FIG. 1, for each polarization per geostationary satellite location. The satellite has two downlink polarizations. For DBS systems, which generally use circular polarization, the two polarizations are right-hand-circular-polarization (RHCP) and left-hand-circular-polarization (LHCP). For FSS systems, which generally use linear polarization, the two polarizations are vertical polarization and horizontal polarization. It is typical for video type transmissions that each geostationary downlink has 16 transponders per polarization; giving a total of 32 transponders for each downlink.

For the multi-switch system, as shown in FIG. 2, it is typical that a low-noise-block-down-converter (LNB) converts the downlink frequency (12.2 to 12.7 GHz for BSS or 11.7 to 12.2 GHz for FSS) to an intermediate frequency (IF) of 950-1450 MHz. In a system receiving two satellite locations and feeding four receivers, the four 500 MHz IF bands from two satellites are connected to a 4×4 multi-switch coupler. Each receiver can select any one of these four 500 MHz bands randomly. It is common practice in the multi-switch system to use the same coaxial cable from receiver to the multi-switch to supply DC power to the multi-switch and LNB. Also, it is common practice to use 13V DC to select RHCP (or vertical polarity for FSS) and 18V DC to select LHCP (or horizontal polarity for FSS), and to use 22 kHz continuous tone to select the second satellite.

For the stacked-band/multi-switch hybrid system, as refer to FIG. 3, the stacked-band LNB usually converts satellite downlink frequency to an intermediate frequency band of 950-2150 MHz. This IF band includes two 500 MHz bands and a 200 MHz guard (gap) band. Other slightly different IFs and guard bands are also common. The two 1200 MHz wide stacked bands may then be delivered to four receivers using a 2×4 multiswitch coupler. The receivers can decode these 1200 MHz stacked bands directly; or use a de-stacker to restore two 950-1450 MHz bands. It is common that this type of system uses 18V for DC power and 22 kHz continuous tone to select the second satellite.

The above described systems using a continuous 22 kHz tone to select a second satellite are restricted to reception of only two satellites. With the requirement for the reception of more than two satellite locations, it has become common in both Europe and the USA to use the digital-satellite-equipment-control (DiSEqC) protocol to control satellite devices. The standard was developed and set by Eutelsat. The standard has two different primary versions, DiSEqC 1.x and DiSEqC 2.x. DiSEqC 1.x is for one way command systems; and DiSEqC 2.x is for two way command and communication systems. The DiSEqC system uses coded bursts of 22 kHz tone to provide digital commands, as shown in FIG. 4. These commands typically have a duration of approximately 100 milliseconds and occur typically at channel change in a receiver. A microcontroller is used to process the commands. The DiSEqC system is increasingly and commonly used in satellite systems. Some satellite systems in USA and Europe use DiSEqC to command multi-switches and other devices.

All the above systems suffer the disadvantage of requiring one coax cable per receiver. For a large system with many receivers, this can become very cumbersome.

A recently developed type of system, pioneered by Kathrein Antenna and Electronics and later refined by ST Microelectronics is capable of feeding a plurality of receivers (e.g. 4, 8), each of which may select any transponder from several satellites via a single coax cable. FIG. 5 shows this system in a multi-satellite and a 4 receiver system. The system uses fixed frequency slot positions for transmission; there are four slots (in this 4 tuner example) in FIG. 5. The 4-slot transponder selector can randomly choose any transponder from any of the down-converted 950-1450 MHz IF bands and put the selected transponder into a specified slot. As such, the coaxial cable only transmits four transponders (in this 4 tuner example) at a time. A 4-tuner receiver can pick up the four transponders at same time. By using a command signaling system, each tuner can randomly choose any transponder from the down-converted 950-1450 MHz (or 950-2150 MHz) IF bands. This system solves the problem of feeding several 950-1450 MHz or 950-2150 MHz IF bands along a single coaxial cable.

Thus the input to the set-top-box (STB) tuner at its input coaxial connector will be 4 transponders (in the case of a 4 STB system) in the range 950-2150 MHz. The tuner coaxial connector also has (typically)+18VDC for powering external electronics equipment and data (typically in DiSEqC format). The data from the STB in the form of a digital word is typically commanding:

1. This is STB A. (A is STB 1, 2, 3 or 4 in this example)

2. Send Satellite B. (B is one of the available satellites)

3. Send Transponder (center frequency) C. (C is one of the available transponders)

4. Send Polarization D. (D is one of the two available polarizations)

5. Send it on center frequency E. (E is the output frequency dedicated to STB A)

In the DiSEqC control system, the receiver, commonly referred to as the set-top-box (STB) is a DiSEqC MASTER device (as described in the Eutelsat DiSEqC control system descriptions) with a defined 15 ohm source impedance for the low frequency DiSEqC control signals. It must be connected to a DiSEqC SLAVE device device (as described in the Eutelsat DiSEqC control system descriptions) which has high impedance (typically 500 ohms). The signal source, e.g. satellite LNB is a DiSEqC SLAVE device.

When several different signals are distributed to different receivers along the same cable (typically coaxial cable), a coupler (such as a splitter or directional coupler) will be used to feed the multiple receivers. Normal RF performance is required at the broadcast frequencies (54-2150 MHz), but it must behave as a DiSEqC SLAVE at each output (so that each STB is connected to a SLAVE); and must behave as a MASTER at its input (so that the LNB or similar device is connected to a MASTER).

The MASTER/SLAVE issue may not be a problem with a multi-tuner receiver, as it can control the DiSEqC signaling for each tuner. However, if the receiving system is for several independent receivers (e.g. 4 in FIG. 6), there are problem issues which need to be addressed. The problems are:

1. Control signal (e.g. DiSEqC) command collisions. If two receivers are sending commands at same time or an overlapping time, the two commands will collide with each other. This invention prevents this from happening.

2. Control signal (e.g. DiSEqC) command confusion. If two or more receivers are sending command one after another in short time frame, the transponder selector responding to the first command in 2-way DiSEqC systems will be mistaken by the other receivers as the response to their command. Also data from the transponder selector being sent to the first STB may collide with data being sent by a second STB. This invention prevents this from happening.

3. A satellite receiver is a DiSEqC MASTER and may only be connected to a DiSEqC SLAVE(s). If a plurality of receivers (e.g. 4) are connected to the same coax cable, this will result in 4 MASTER devices being connected together directly due to the low frequency characteristics of typical splitters and couplers in as described in paragraph 0003. The low impedance of the MASTER devices which would be connected together will result in attenuation and/or corruption of the DiSEqC commands. This invention describes a new design of coupler which behaves as a MASTER at its input and as a SLAVE at each output.

### SUMMARY

This invention is a multi-receiver coupler described here in the form a 4 way power divider (splitter), but splitters with a different number of outputs and directional couplers are also equally possible. This newly invented signal coupler addresses the above problem issues.

Signal splitters for the broadcast frequency range of 54-2150 MHz are usually designed using:

1. Printed microstrip lines on a printed circuit board (e.g. Wilkinson splitter).

2. Inductive hybrid and transformer circuits, often with ferrite cores.

3. Resistive power divider networks.

Directional Couplers for the broadcast frequency range of 54-2150 MHz are usually designed using:

4. Printed microstrip lines on a printed circuit board.

5. Inductive transformer circuits, often with ferrite cores.

Modifications and additional circuitry to the above signal couplers address the problem issues described.

### DESCRIPTION OF THE DRAWINGS

The following drawings and exemplary embodiments are referenced for explanation purposes.

FIG. 1 illustrates a conventional satellite band frequency plan;

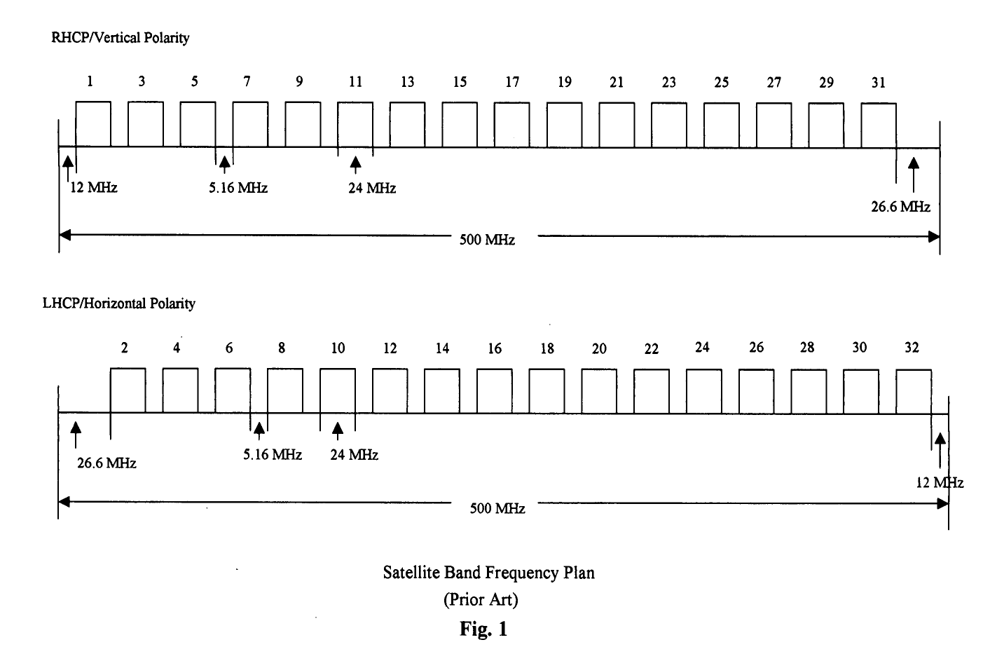

FIG. 2 illustrates a conventional 4-unit multi-switch system.

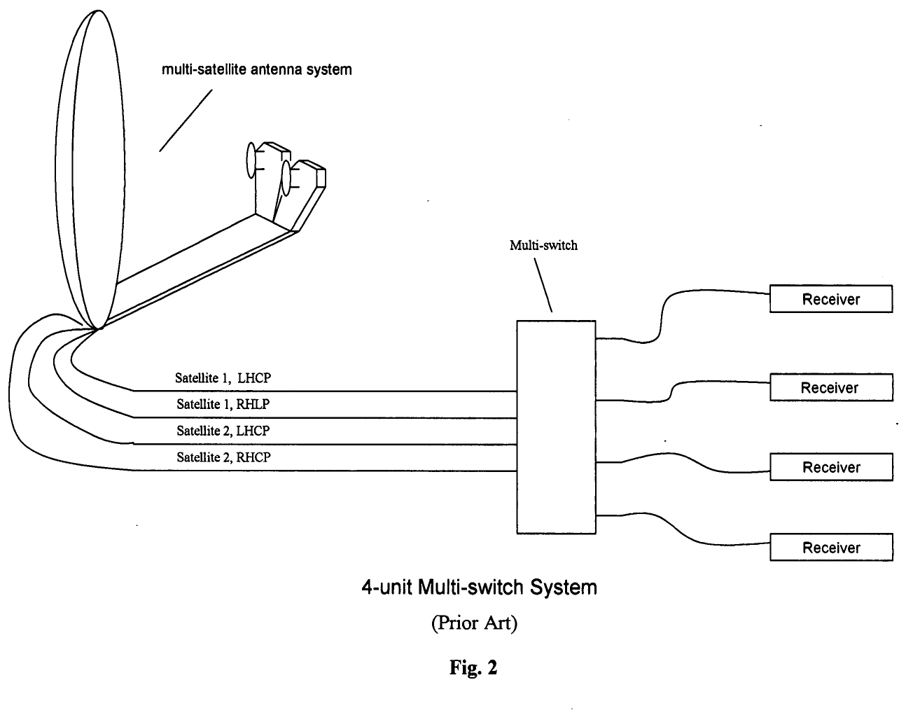

FIG. 3 illustrates a conventional 4-unit stacked band & multi-switch hybrid system.

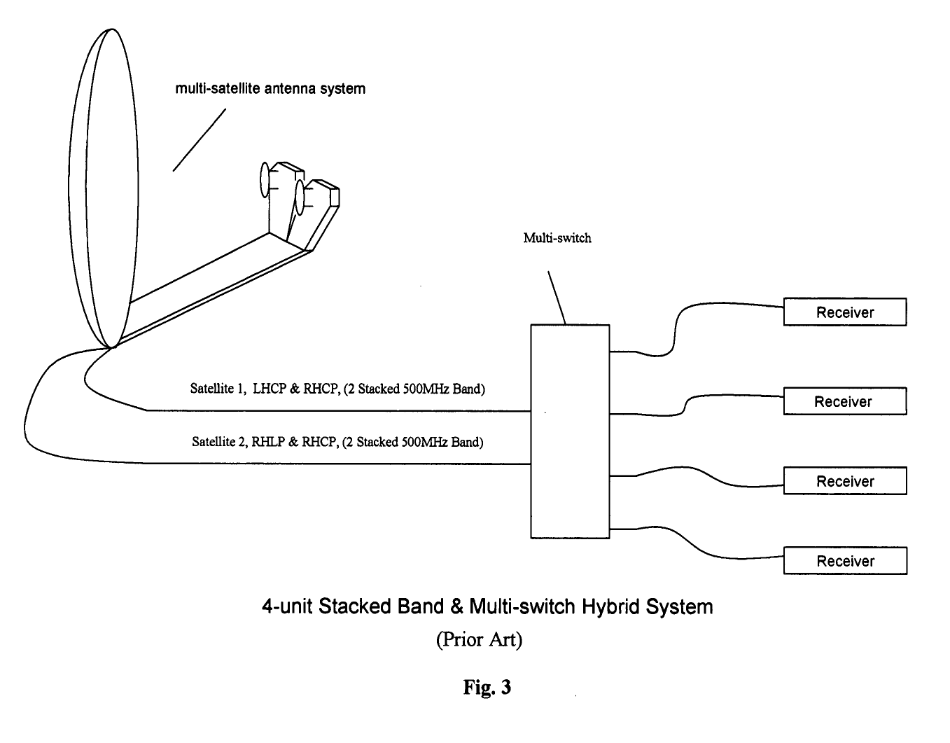

FIG. 4 illustrates a conventional DiSEqC bus command structure.

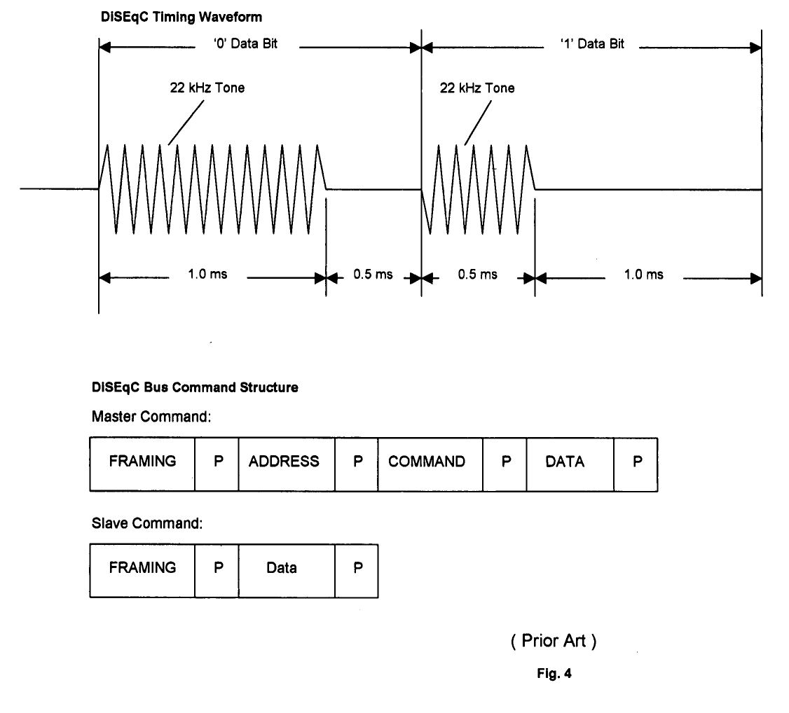

FIG. 5 illustrates a conventional 4-slot one cable system.

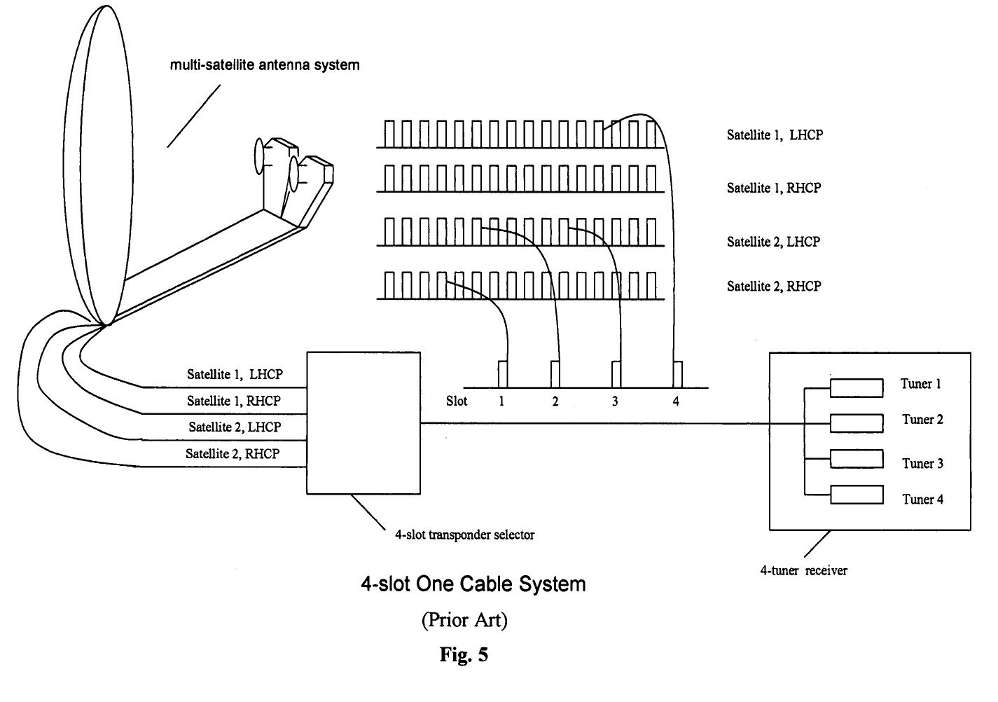

FIG. 6 illustrates a smart splitter for a one cable system according to one preferred embodiment of the present invention.

FIG. 7 illustrates a detailed block diagram of a “smart splitter” according to one preferred embodiment of the present invention.

### DETAILED DESCRIPTION OF THE PREFERRED EMBODIMENTS

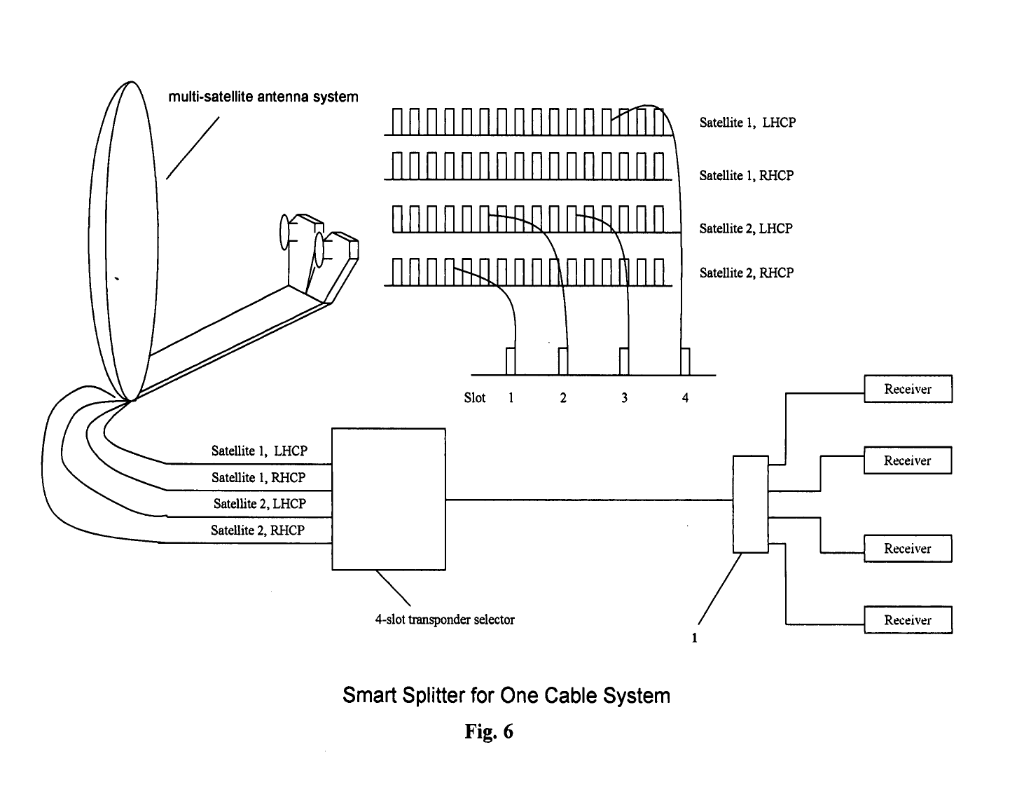

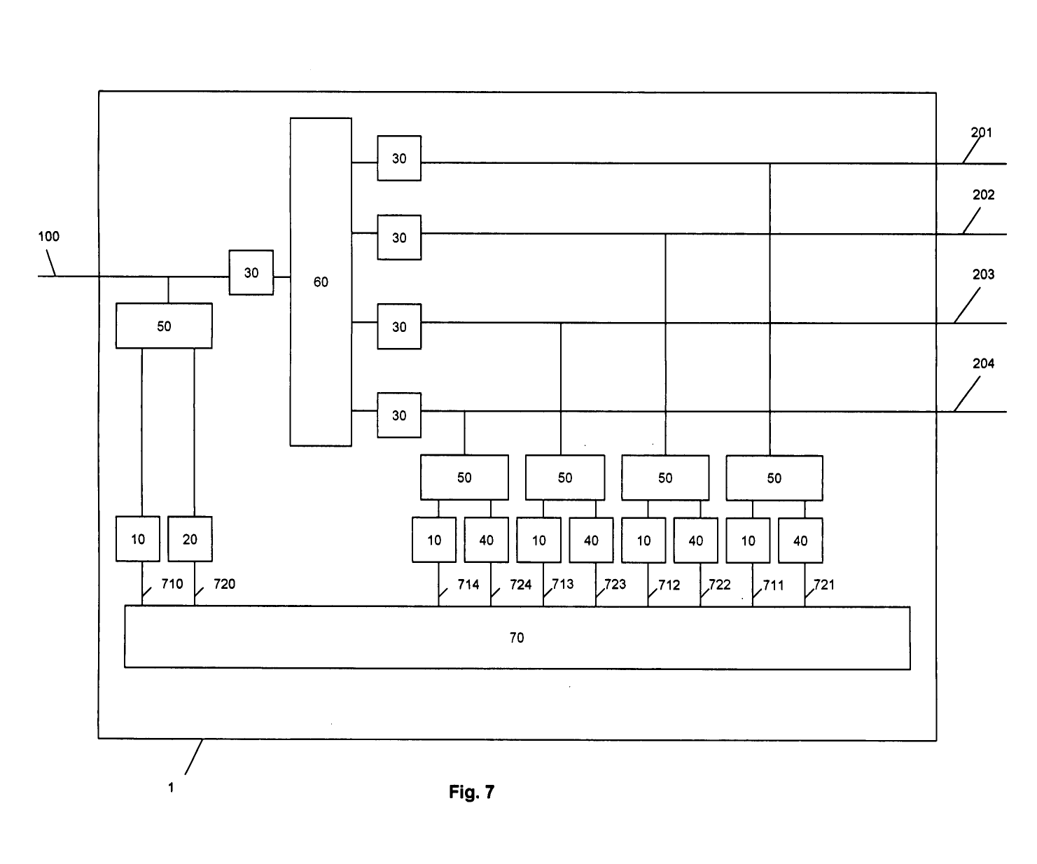

The application of present invention is shown in FIG. 6 using a 4-way splitter as an example. The “smart splitter” 1 is connected between a 4-slot transponder selector and four receivers. All selected four transponders are passed to each receiver. However, each receiver is tuned to only one slot. The four receivers have one-to-one relationship to the four slots. The detailed functional block diagram is in FIG. 7.

The conventional 4-way splitter 60 is for power dividing the RF signal in the range 54-2150 MHz. Each input and output port of the splitter 60 passes through the filter 30 which is a high pass filter to prevent the low frequency control signals (bursts of 22 kHz tone, in the case of DiSEqC) passing to the RF splitter.

One receiver sends a DiSEqC control signal to port 201. The DiSEqC signal is then sent to the tone burst passing filter 50, which could be as simple as a 22 kHz low pass filter. The tone burst passing filter 50 passes the DiSEqC signal to tone burst decoder 10, which may be constructed from a 22 kHz amplifier and detector. The tone burst decoder 10 exhibits the slave type load impedance specification. The decoder 10 converts the tone burst signal to a digital signal which is passed to pin 711 of the microcontroller 70. The microcontroller 70 is a microprocessor with memory. The microcontroller 70 processes the control signal and stored receiver and command information into memory. Then, the microcontroller sends a control signal to pin 720 in digital format The following tone burst encoder 20 encodes the digital signal into a DiSEqC tone burst signal per the master type drive specification. The generated DiSEqC signal passes through the tone burst passing filter 50 sends the control signal out to the transponder selector through port 100.

For systems using 2-way data communication, e.g. DiSEqC 2.x, the response DiSEqC signal from the transponder selector goes through port 100, then to tone burst passing filter 50, then to tone burst decoder 10. The decoder 10 converts the tone burst signals into a digital word and passes the digital word via pin 710 to the microcontroller 70. The microcontroller 70 checks the communication log and finds out which output port this message is related to. For example, if the microcontroller 70 finds out the message is relevant to output port 201; then, the microcontroller 70 passes the message to pin 721 to tone burst encoder 40. The tone burst encoder 40 encodes digital signal to tone burst format DiSEqC signals according to the slave type specification. These signals pass through tone burst passing filter 50, then to the specific receiver via port 201.

Because the Diseqc driver circuits of the receiver (set-top-box) are of the master type, the “smart splitter” 1 is connected to four master type drivers in FIG. 6 in the four receivers. However the system hierarchy only allows one master for many slaves, but many masters for one slave is not allowed. For the system in FIG. 6, the smart splitter 1 masks each receiver from other receivers, thus preventing masters from being connected to each other. It similarly ensures that each receiver connects to only its own slave unit at the splitter port

The “smart splitter” 1 receives and stores the commands from all four receivers. If two receivers send a command at the same or an overlapping time, the smart splitter 1 receives both commands and stores them. This action is possible because the microcontroller 70 includes a memory function (either internal or external) and is much faster than the DiSEqC tone burst command. The smart splitter can then send out the commands in an orderly, sequential manner. In this way, the smart splitter 1 solves the collision problem caused by simultaneous or overlapping commands from a receiver to the transponder selector.

In two way data communication, such as in DiSEqC 2.x systems, the microcontroller can direct the return command from the transponder selector to only the receiver which initiated the communication. This will prevent collisions between a receiver command and a return command to a different receiver from colliding.

While the present invention has been particularly shown and described with reference to preferred embodiments thereof, it will be understood by those of ordinary skill in the art the various changes in form and details may be made therein without departing from the spirit and scope of the present invention as defined by the appended claims.

We claim:

1. A bidirectional signal coupler for distribution of multi-satellite broadcast TV signals on a single coaxial cable line, having additional capacities of data collision protection and impedance buffering, the signal coupler comprising:
a multi-way RF coupler with one input port and a plurality of output ports for power dividing RF signals in a range 54-2150 MHz, where the coupler is capable of passing low frequency in both directions;
wherein the coupler exhibiting Diseqc MASTER characteristics at the input and Diseqc SLAVE characteristics at each output where set top boxes (STBs) are connected to the coupler outputs;
an external frequency translation device connected to the coupler input;
a high pass filter coupling to the input port and each output port;
a tone burst passing filters coupling to the high pass filter; and
a microcontroller for processing control signals and storing command information, such that the control signals from different STBs which may be initiated at the same or an overlapping time are passed in a sequential, orderly manner to an external frequency translation device where the microcontroller directs a return command from the frequency translation device only to the receiver which initiated the communication,
whereby at the input, circuitry is employed according to the Diseqc MASTER specification to enable modulated signals to be generated using data received from the microcontroller which are then passed to the external frequency translation device, and for modulated signals to be received from the external frequency translation device and passed to the microcontroller, and
whereby at each output, circuitry is employed according to the Diseqc SLAVE specification to enable modulated signals to be received from the set-top-box and passed to the microcontroller, and for modulated signals to be generated using data received from the microcontroller which are then passed to the set-top-box.

2. The signal coupler of claim 1, wherein the multi-way RF coupler is a splitter (power divider) or a directional coupler.

3. The signal coupler of claim 1, wherein the RF coupler is also capable of passing low frequency control signals of 22 KHz DiSEqc 1.x or 2.x in either direction.

4. The signal coupler of claim 1, wherein the high pass filters are to prevent low frequency control signals passing to the RF coupler.

5. The signal coupler of claim 1, wherein the tone burst passing filter is a 22 kHz low pass filter.

6. The signal coupler of claim 1, wherein the microcontroller is a microprocessor with memory.

7. The signal coupler of claim 1, further comprising a plurality of tone burst decoders constructed from a 22 kHz amplifier and detector and exhibiting the slave type load impedance specification at each output, and master type impedance specification at the input.

8. The signal coupler of claim 1, wherein each output produces 22 KHz modulated digital signals to be received by the STB using data received from the microcontroller based on the slave type load impedance specification.

9. The signal coupler of claim 1, wherein the input produces 22 KHz modulated digital signals to be received by the external frequency translation device using data received from the microcontroller based on the master type source impedance specification.

10. The signal coupler of claim 1, wherein each output receives (by amplifying and detecting) 22 KHz modulated digital signals from the STB based on the slave type load impedance specification, and the data is then passed to the microcontroller.

11. The signal coupler of claim 1, wherein the input can receive (by amplifying and detecting) 22 KHz modulated digital signals from the frequency translation device based on the master type source impedance specification, and the data is then passed to the microcontroller.
